(19) United States
(12) Patent Application Publication
(10) Pub. No.: US 2003/0067435 A1
(43) Pub. Date: Apr. 10, 2003

(54) Adaptive gamma curve correction apparatus and method for a liquid crystal display

(76) Inventor: Hong-Da Liu, Hsinchu (TW)

Correspondence Address: RABIN & CHAMPAGNE, P.C., Suite 500, 1101 14th Street, N.W., Washington, DC, 20005, US

(21) Appl. No.: 09/969,985

(22) Filed: Oct. 4, 2001

(51) Int. Cl. G09G 3/36

(52) U.S. Cl. 345/101

(57) ABSTRACT

An adaptive gamma curve correction apparatus and method for an LCD with multiple display modes or various display states provides more than one gamma curves to the LCD to adapt the display performance of the LCD for various display mode or state. Each gamma curve is prepared corresponding to a suitable display mode or state to optimize the LCD. The gamma curves are switched to be selected a suitable one when a display mode is in operation.

### FIELD OF THE INVENTION

The present invention relates generally to a liquid crystal display (LCD), and more particularly to, an adaptive gamma curve correction apparatus and method for an LCD with multiple display modes or various display states.

### BACKGROUND OF THE INVENTION

LCDs are conventionally identified with tow types, reflection type and transmission type. In a reflective LCD, as shown in FIG. 1A, the ambient light 10 in front of an LCD passes through the LCD 12 and is then reflected back through the LCD 12 by a reflector 14 so as to become the display light 16 to the viewer. When the ambient light 10 is weak or the environment is not bright enough for the viewer, a clear image display will not be obtained. In addition, the modulation efficiency in an LCD is poor, that requests more strictly to the ambient light intensity for a clear image display. As shown in FIG. 1B, a transmissive LCD can overcome the drawback of the low light intensity with a backlight 18 provided by a light source. In a transmissive LCD, the backlight 18 passes the LCD 12 and becomes the display light 16 to the viewer. However, the light source to provide the backlight 18 consumes electric power. That is also disadvantageous to reduce the scale and the weight of an LCD arrangement. Moreover, when the environment is bright, a transmissive LCD still cannot save the electric power for the backlight, as in a reflective LCD. A solution is proposed with a transflective LCD, which is a combination of the reflection type LCD and the transmission type LCD. In a transflective LCD, as shown in FIG. 1C, the ambient light 10 passing through the LCD 12 is partially reflected by a transflector 20 which also permits the backlight 18 to pass through. The transflective LCD has two display modes, reflection display mode and transmission display mode. When the ambient light 10 is intense enough, the electric power for the backlight 18 can be saved. Contrarily, the backlight source is turned on when the environment is dark.

However, a problem is introduced into a transflective LCD since the reflective LCD and the transmissive LCD have different optical characteristics. A typical display system is illustrated in FIG. 2, in which a controller 20 receiving video signal generates a display data signal D transmitted to a data driver 26 and a scan signal S transmitted to a scan driver 24 to drive the LCD panel 28. To correct the nonlinearity of the transmittance/reflectance to the driving voltage of the LCD panel 28, the data driver 26 is provided with a gamma curve correction apparatus to supply a correction data called gamma curve 30 which is dependent on the LCD panel 28. Unfortunately, the gamma curve for a reflective LCD is different from that for a transmissive LCD if the both types of LCDs are optimized. When the optical efficiency or performance is optimized in a transflective LCD, the gamma curve for the image gray level in the reflection display mode is different from the gamma curve for the image gray level in the transmission display mode. As a result, the display quality degrades in a transflective LCD.

Further, the performance of an LCD with a prefixed gamma curve also degrades when environment temperature is changed, since the optical characteristics of liquid crystal are temperature dependent. The prior art gamma curve correction apparatus thus cannot be adaptive to environment conditions.

Therefore, it is desired an adaptive gamma curve correction apparatus and method for an LCD with multiple display modes or various display states.

### SUMMARY OF THE INVENTION

One object of the present invention is an adaptive correction for the gamma cure provided to an LCD with multiple display modes or various display states.

In an LCD with multiple display modes or various display states, according to the present invention, each display mode or state thereof is prepared with a respective gamma curve in advance, and when switched between the display modes or states, the LCD is provided with the corresponding gamma curve.

In a hardware implemented embodiment, two voltage dividers are employed to generate an R-V curve for a reflection display mode and a T-V curve for a transmission display mode selected by a switch controlled by a mode signal to provide a suitable gamma curve. In a digital implementation embodiment, a memory is employed to store an R-V curve for a reflection display mode and a T-V curve for a transmission display mode in a digital form, and an addresser is controlled by a mode signal to read out a suitable gamma curve from the memory. In a software implemented embodiment, a memory stores parameters corresponding to an R-V curve for a reflection display mode and a T-V curve for a transmission display mode, and a gamma curve generator controlled by a mode signal calculates a gamma curve based on the suitable parameters stored in the memory.

In a temperature adaptive embodiment, a thermal couple is employed to sense the environment temperature and thus to select a suitable gamma curve from a plurality of gamma curves prepared for various temperature conditions.

With a plurality of gamma curves prepared for multiple display modes or states in advance, the present invention can adapt an LCD for its display performance by switching between the gamma curves.

### BRIEF DESCRIPTION OF THE DRAWINGS

For a better understanding of the present invention, reference may be had to the following description of exemplary embodiments thereof, considered in conjunction with the accompanying drawings, in which:

FIGS. 1A-1C show three different types of LCDs;

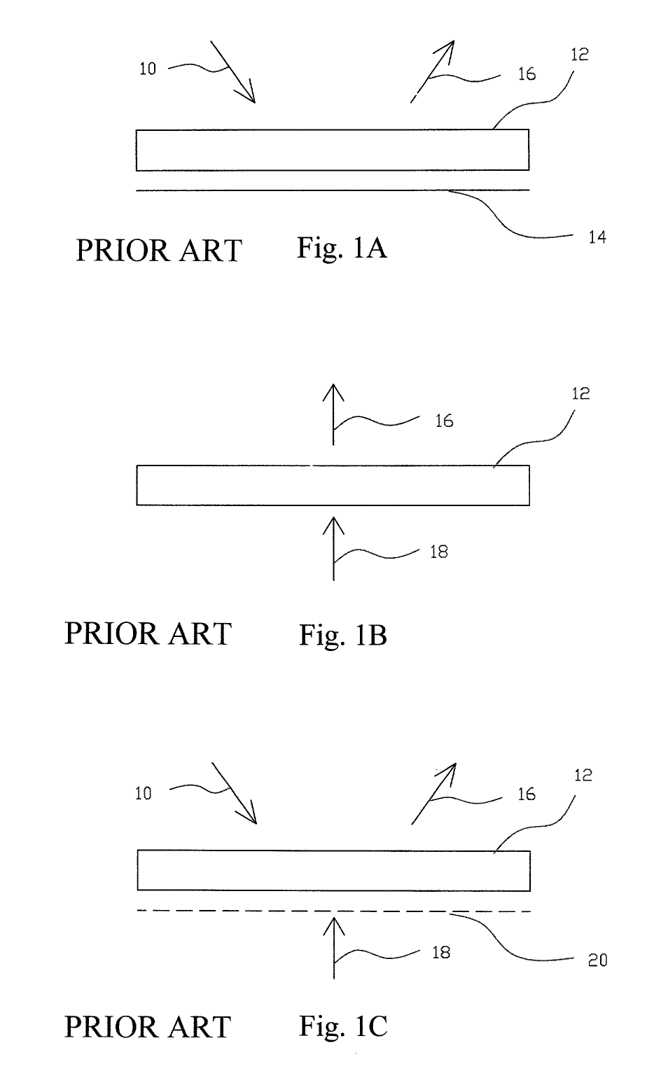

FIG. 2 shows the block diagram of a typical display system for an LCD;

FIG. 3 shows the block diagram of a display system for an LCD with multiple display modes according to the present invention;

FIG. 4 shows an R-V curve and a T-V curve for the gamma curve in a display system for an LCD according to the present invention;

FIG. 5 shows the circuit diagram of the first embodiment gamma curve correction apparatus according to the present invention;

FIG. 6 shows the block diagram of the second embodiment gamma curve correction apparatus according to the present invention;

FIG. 7 shows the block diagram of the third embodiment gamma curve correction apparatus according to the present invention; and

FIG. 8 shows the block diagram of a display system for an LCD with temperature adaptation according to the present invention;

### DETAILED DESCRIPTION OF THE INVENTION

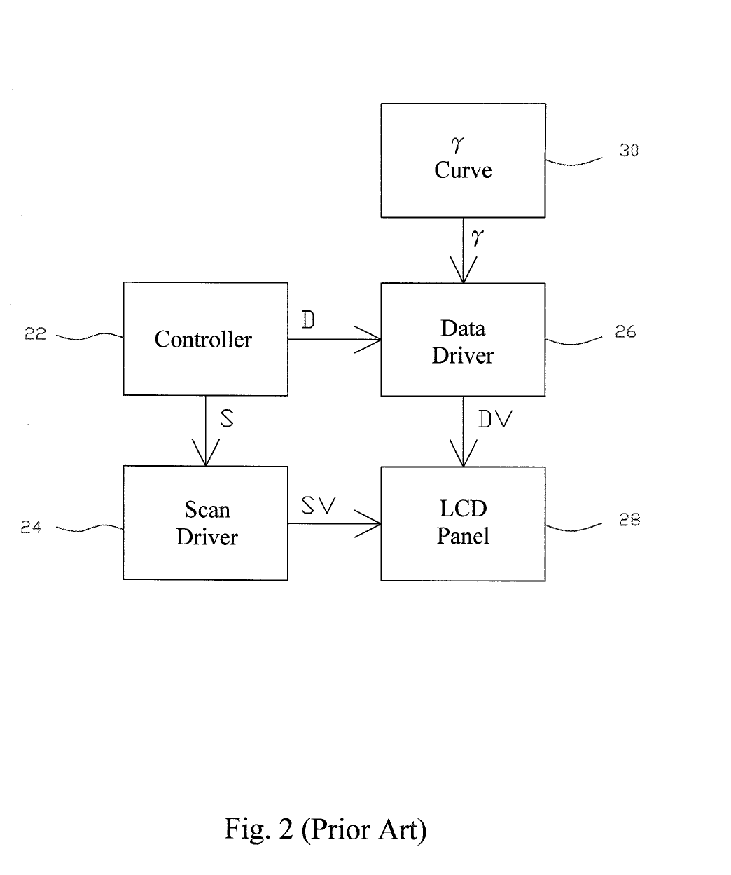

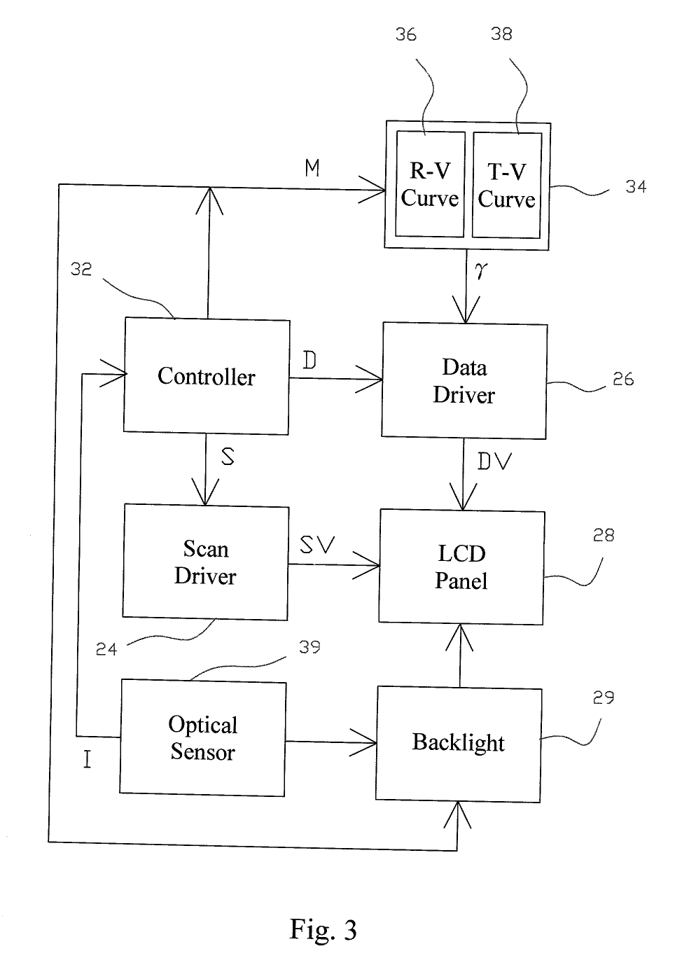

As for a display system of the present invention, FIG. 3 shows a block diagram for a transflective LCD similar to a conventional one shown in FIG. 2. A controller 32 receives video signal and generates display data signal D and scan signal S. A data driver 26 receives the display data signal D from the controller 32 and generates data voltages DV for the image gray level to drive the sources of the thin film transistors (TFT) array (not shown) in the LCD panel 28. On the other hand, a scan driver 24 receives the scan signal S from the controller 32 and generates the scan voltages SV for the scan lines to drive the gates of the TFT array in the LCD panel 28. A backlight 29 is prepared to be projected to the LCD panel 28 for the transmission display mode. To correct the nonlinearity of the LCD panel 28, a gamma curve correction apparatus 34 supplies the data driver 26 with a gamma curve γ. However, there are two gamma curves prepared by the gamma curve correction apparatus 34, they are an R-V curve 36 for the reflection display mode and a T-V curve 38 for the transmission display mode, and the output γ of the gamma curve correction apparatus 34 is switched between the R-V curve 36 and the T-V curve 38. The selection of the R-V curve 36 and the T-V curve 38 is controlled by a mode signal M from the controller 32. When the LCD panel 28 is operated in the reflection display mode, the controller 32 selects the R-V curve 36 in the gamma curve correction apparatus 34 by the mode signal M to supply to the data driver 26. When the transmission display mode is desired, the controller 32 turns on the backlight 29 and switches the gamma curve γ to the T-V curve 38 in the gamma curve correction apparatus 34 by the mode signal M. In this embodiment, the mode signal M is also used to turn on or turn off the backlight 29, the gamma curve correction apparatus 34 is therefore switched to the T-V curve 38 simultaneously to enable the backlight 29 when switched from the reflection display mode to the transmission display mode.

To further enhance the automatic adaptation, an optical sensor 39 is used to monitor the environment light intensity in such a manner that the transmission display mode is enabled by the optical sensor 39 depending on one or more preset thresholds. When the environment is dim, the sensed signal by the sensor 39 reaches the preset threshold and thus issues an illumination notification signal I to switch to the transmission display mode, i.e., the backlight 29 is turned on and the gamma curve correction is switched to the T-V curve 38. The optical sensor 39 can directly turn on the backlight 39 and then trigger the mode signal M by another signal, or the optical sensor 39 can active the cortroller 32 to trigger the mode signal M to simultaneously turn on the backlight 39 and switch to the T-V curve 38. In addition, the threshold to switch the display mode can be planed in consideration of environment illumination and its fluctuation in time.

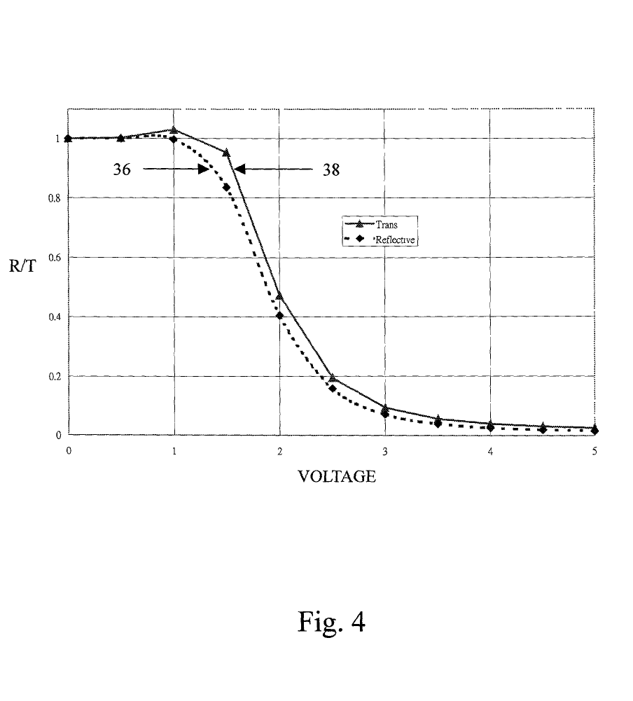

For an exemplary practice, FIG. 4 provides an R-V curve 36 and a T-V curve 38 measured on a real transflective LCD to show their characteristics and distinguish between them. As well-known in the art, the reflectance is smaller than the transmittance for each specific voltage in the transition region between the black and white display voltage levels. Such a difference between the R-V curve 36 and the T-V curve 38 will degrade the display performance unless respective gamma curves are biased for the different display modes. Therefore, the display performance cannot be improved if only one gamma curve is used for both the reflection display mode and the transmission display mode.

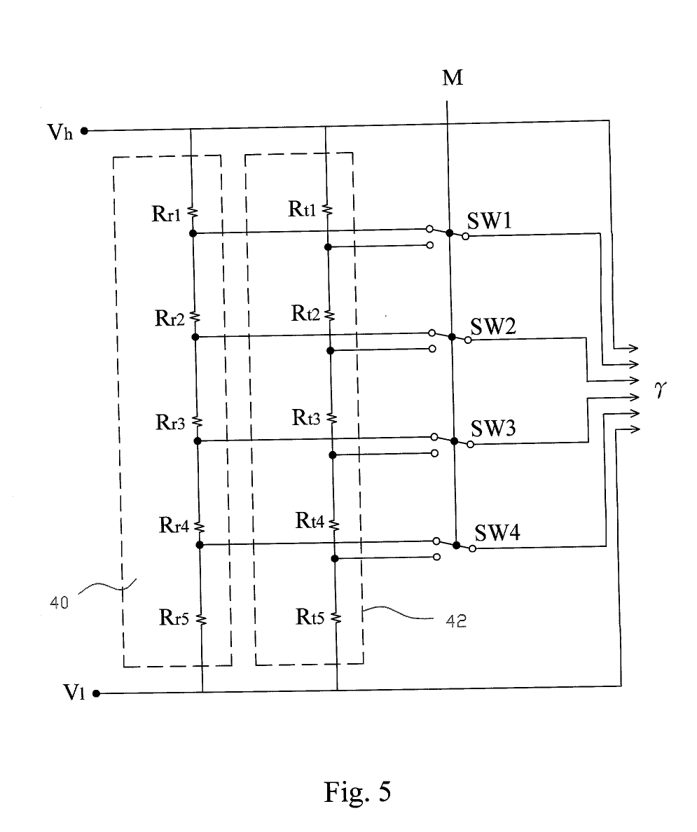

A hardware approach for the gamma curve correction apparatus 34 is illustrated in FIG. 5. In this apparatus two voltage dividers 40 and 42 respectively for the reflection display mode and the transmission display mode are connected in parallel and have their two end nodes connected respectively to a high voltage source Vh and a low voltage source V1. In other embodiments, the high voltage sources and the low voltage sources can be different for the voltage dividers corresponding to different display modes. In the present embodiment the voltage divider 40 for the reflection display mode is composed of five resistors Rr1, Rr2, Rr3, Rr4, and Rr5 connected in series, and the voltage divider 42 for the transmission display mode is also composed of five resistors Rt1, Rt2, Rt3, Rt4, and Rt5 connected in series. Both of the voltage dividers 40 and 42 are tapered to provide the gamma curve voltages to be coupled with switches SW1, SW2, SW3, and SW4. The switches SW1-4 are controlled by a mode signal to simultaneously switch to the voltage divider 40 or to the voltage divider 42. Thus, two respective gamma curves can be controlled to provide for the reflection display mode and the transmission display mode.

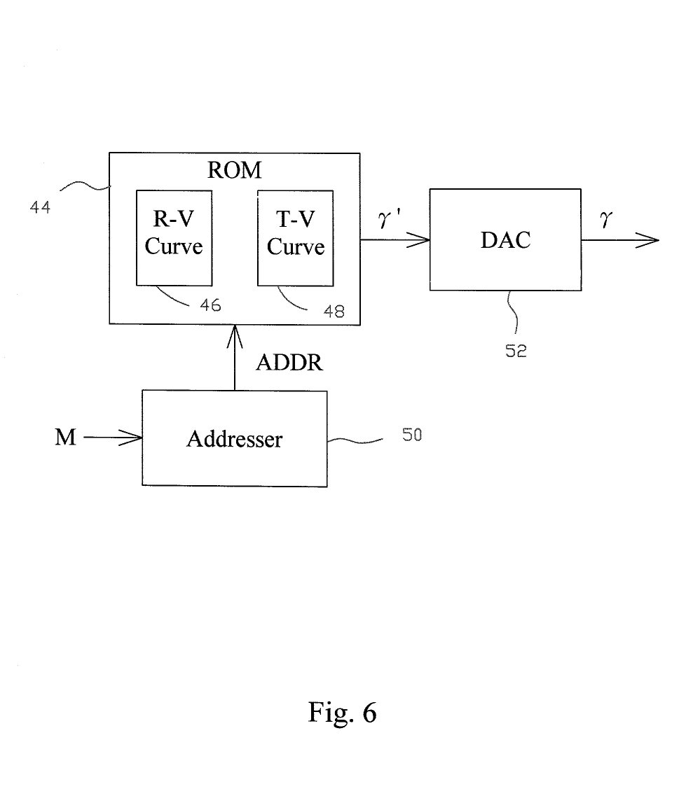

FIG. 6 is another embodiment of the present invention to supply digital gamma curves. An R-V curve 46 and a T-V curve 48 are stored in a read only memory (ROM) 44 in a digital form, i.e., the values of both the gamma curves 36 and 38 are sampled and stored in the ROM 44 in advance. An addresser 50 is controlled by a mode signal M to generate a proper address ADDR to read out the data of the R-V curve 46 or the T-V curve 48 to be outputted. If needed, the digital gamma curve γ′ from the ROM 44 can be further transformed to be analog voltages by a digital to analog converter (DAC) 52. In this manner, the gamma curve to be supplied is searched from a look-up table, which is suitable for a totally digital display system.

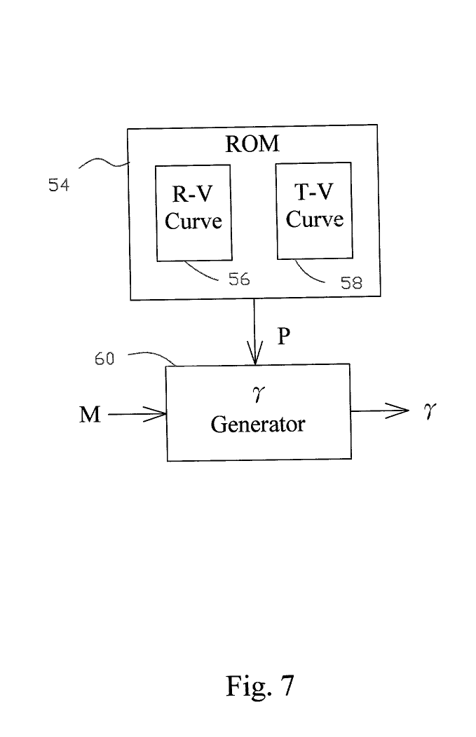

A software implemented embodiment of the present invention is provided in FIG. 7. In this approach, only the basic parameters for an R-V curve 56 and a T-V curve 58 are stored in a ROM 54, this way the storage volume can be reduced. A gamma curve generator 60 is controlled by a mode signal M to fetch the proper parameters P from the ROM 54. In the gamma curve generator 60 a process is executed to calculate the gamma curve values based on the fetched parameters. The software in the gamma curve generator 60 can be updated for different systems. As in the prior art, the real gamma curve can be approached by a finite points method, thus only some points data and an equation are required for the parameters, which makes the calculations executed by the gamma curve generator 60 simplified. The approach curves can be directly derived from the real R-V curve and T-V curve, such as shown in FIG. 4.

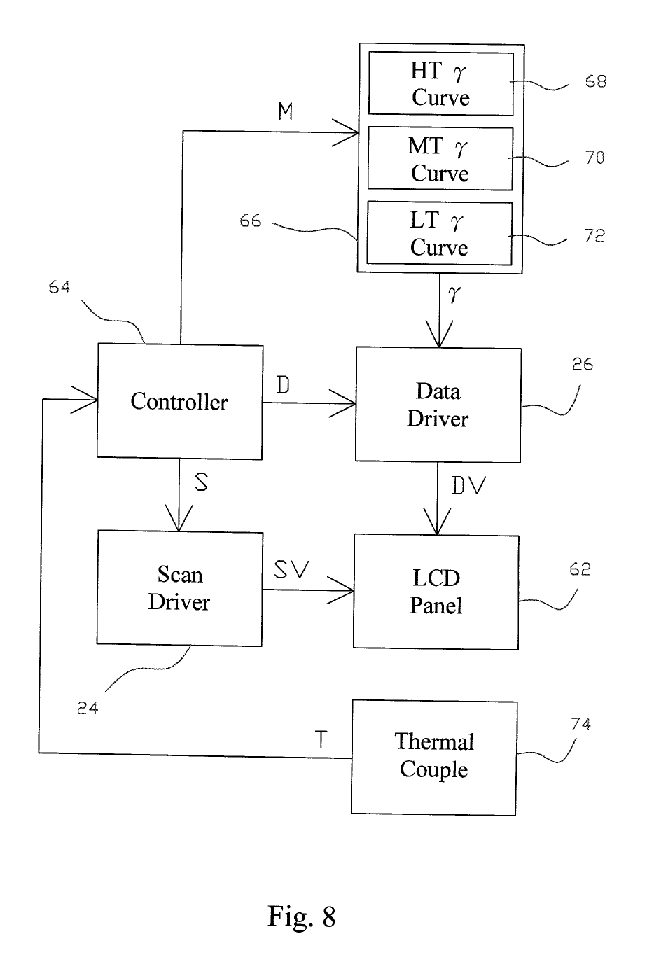

FIG. 8 shows the block diagram of a display system for an LCD with temperature adaptation. In this system, a reflective LCD panel 62 is optimized by a gamma curve correction apparatus 66 switched by a controller 64 with the help of a thermal couple 74. There are prepared in the gamma curve correction apparatus 66 with three temperature dependent gamma curves, high temperature (HT) gamma curve 68, middle temperature (MT) gamma curve 70, and low temperature (LT) gamma curve 72, for the LCD panel 62 to be operated in different temperature ranges. The thermal couple 74 monitors the environment temperature and issues a temperature notification signal T to the controller 64 to select a suitable gamma curve among the gamma curves 68, 70, and 72 to be supplied to the data driver 26. In other embodiments, the gamma curve correction apparatus 66 can be directly switched by the thermal couple 74 with the signal T served as the mode signal M.

It is apparently for the multiple gamma curves to be applied to reflection type LCD, transmission type LCD, partial reflection type LCD, and transflection type LCD, twisted nematic (TN) LCD and super-twisted nematic (STN) LCD, thin film transistor (TFT) LCD, thin film diode (TFD) LCD, and metal insulator metal (MIM) LCD, and various working temperatures.

From the above, it should be understood that the embodiments described, in regard to the drawings, are merely exemplary and that a person skilled in the art may make variations and modifications to the shown embodiments without departing from the spirit and scope of the present invention. All variations and modifications are intended to be included within the scope of the present invention as defined in the appended claims.

What is claimed is:

1. An adaptive gamma curve correction apparatus for an LCD comprising:
an LCD panel with a plurality of display modes or states;
a plurality of voltage dividers respectively corresponding to a plurality of gamma curves for said a plurality of display modes or states; and
means controlled by a mode signal for switching between said a plurality of voltage dividers to provide an adaptive gamma curve for said LCD panel.

2. An apparatus according to claim 1 wherein said LCD panel is selected from the group of reflection type LCD, transmission type LCD, partial reflection type LCD, and transflection type LCD.

3. An apparatus according to claim 1 wherein said LCD panel is selected from the group of TN-LCD and STN-LCD.

4. An apparatus according to claim 1 wherein said LCD panel is selected from the group of TFT-LCD, TFD-LCD, and MIM-LCD.

5. An apparatus according to claim 1 wherein said display modes comprises reflection display mode and transmission display mode.

6. An apparatus according to claim 1 wherein said display states comprises various temperature states.

7. An apparatus according to claim 6 further comprising a thermal couple for monitoring environment temperature to automatically switch between said a plurality of gamma curves corresponding to said various temperature states.

8. An apparatus according to claim 1 further comprising a backlight for projecting to said LCD panel.

9. An apparatus according to claim 8 further comprising an optical sensor for monitoring environment light intensity to automatically turn on or turn off said backlight depending on at least one threshold corresponding to said environment light intensity.

10. An apparatus according to claim 7 wherein said mode signal is derived from a switch signal for turning on or turning off said backlight.

11. An adaptive gamma curve correction apparatus for an LCD comprising:
an LCD panel with a plurality of display modes or states;
means for storing a plurality of gamma curves for said a plurality of display modes or states; and
an addresser controlled by a mode signal for reading among said a plurality of gamma curves to be a digital gamma curve.

12. An apparatus according to claim 11 wherein said LCD panel is selected from the group of reflection type LCD, transmission type LCD, partial reflection type LCD, and transflection type LCD.

13. An apparatus according to claim 11 wherein said LCD panel is selected from the group of TN-LCD and STN-LCD.

14. An apparatus according to claim 11 wherein said LCD panel is selected from the group of TFT-LCD, TFD-LCD, and MIM-LCD.

15. An apparatus according to claim 11 wherein said display modes comprises reflection display mode and transmission display mode.

16. An apparatus according to claim 11 wherein said display states comprises various temperature states.

17. An apparatus according to claim 16 further comprising a thermal couple for monitoring environment temperature to automatically switch between said a plurality of gamma curves corresponding to said various temperature states.

18. An apparatus according to claim 11 further comprising a backlight for projecting to said LCD panel.

19. An apparatus according to claim 18 further comprising an optical sensor for monitoring environment light intensity to automatically turn on or turn off said backlight depending on at least one threshold corresponding to said environment light intensity.

20. An apparatus according to claim 17 wherein said mode signal is derived from a switch signal for turning on or turning off said backlight.

21. An apparatus according to claim 11 further comprising a digital to analog converter for transforming said digital gamma curve to an analog signal.

22. An adaptive gamma curve correction apparatus for an LCD comprising:
an LCD panel with a plurality of display modes or states;
means for storing a plurality of gamma curves parameters for said a plurality of display modes or states; and
a gamma curve generator controlled by a mode signal for generating a gamma curve signal based on said a plurality of gamma curves parameters.

23. An apparatus according to claim 22 wherein said LCD panel is selected from the group of reflection type LCD, transmission type LCD, partial reflection type LCD, and transflection type LCD.

24. An apparatus according to claim 22 wherein said LCD panel is selected from the group of TN-LCD and STN-LCD.

25. An apparatus according to claim 22 wherein said LCD panel is selected from the group of TFT-LCD, TFD-LCD, and MIM-LCD.

26. An apparatus according to claim 22 wherein said display modes comprises reflection display mode and transmission display mode.

27. An apparatus according to claim 22 wherein said display states comprises various temperature states.

28. An apparatus according to claim 27 further comprising a thermal couple for monitoring environment temperature to automatically switch between said a plurality of gamma curves corresponding to said various temperature states.

29. An apparatus according to claim 22 further comprising a backlight for projecting to said LCD panel.

30. An apparatus according to claim 29 further comprising an optical sensor for monitoring environment light intensity to automatically turn on or turn off said backlight depending on at least one threshold corresponding to said environment light intensity.

31. An apparatus according to claim 28 wherein said mode signal is derived from a switch signal for turning on or turning off said backlight.

32. An adaptive gamma curve correction method for an LCD comprising the steps of:
preparing an LCD panel with a plurality of display modes or states;
preparing a plurality of gamma curves for said a plurality of display modes or states; and
switching between said a plurality of gamma curves to supply a gamma curve signal.

33. A method according to claim 32 further comprising monitoring environment temperature to automatically switch between said a plurality of gamma curves corresponding to various temperature states.

34. A method according to claim 32 further comprising projecting a backlight to said LCD panel.

35. A method according to claim 34 further comprising monitoring environment light intensity to automatically turn on or turn off said backlight depending on at least one threshold corresponding to said environment light intensity.

36. A method according to claim 32 further comprising storing said a plurality of gamma curves and reading one of said a plurality of gamma curves.

37. A method according to claim 36 further comprising transforming said one of said a plurality of gamma curves to an analog gamma curve signal.

38. A method according to claim 32 further comprising storing a plurality of gamma curves parameters and generating said gamma curve signal based on one of said a plurality of gamma curves parameters.
